(19) United States
(12) Patent Application Publication
(10) Pub. No.: US 2021/0138722 A1
(43) Pub. Date: May 13, 2021

(54) THREE-DIMENSIONAL PRINTING USING A FILAMENT OF THERMOPLASTIC MATERIAL AND A CONDUCTIVE FIBER

(71) Applicant: AIRBUS OPERATIONS S.L., Madrid (ES)

(72) Inventors: Asuncion BUTRAGUENO-MARTINEZ, Getafe (ES); Guillermo HERNAIZ LOPEZ, Getafe (ES); Jose SANCHEZ GOMEZ, Getafe (ES)

(21) Appl. No.: 17/091,306

(22) Filed: Nov. 6, 2020

(30) Foreign Application Priority Data
Nov. 7, 2019 (EP) 19382973-6

(51) Int. Cl. B29C 64/118; B29C 64/245; B29C 64/209; B29C 64/295

(52) U.S. Cl. CPC B29C 64/118; B29C 64/245; B33Y 10/00; B29C 64/295; B29C 64/209

(57) ABSTRACT

A three-dimensional printing system including: a printing bed (3) where a printed material is deposited to form an object (1), a bobbin (4) configured to hold a filament (2) of thermoplastic material reinforced with a continuous electrically conductive element, a printing head (5) fed by the bobbin (4) and configured to deposit, e.g., print, the filament on the printing bed (3) to form an object and first and second electrodes (7, 8) connected to a power supply (6), wherein the first electrode (7) is connected to the printing bed (3), and the second electrode (8) is connected to the filament, wherein an electric circuit is created through the continuous conductive element in the filament to heat the printed material.

### RELATED APPLICATION

This application claims priority to European Patent Application 19382973-6, filed Nov. 7, 2019, the entirety of which is incorporated by reference.

### TECHNICAL FIELD

The invention relates to additive manufacturing, e.g., three-dimensional (3D) printing, of reinforced plastics by using Fused Filament Fabrication (FFF) printers. The invention improves the quality of the printing process.

### BACKGROUND

During the manufacturing process of crystalline and semi-crystalline thermoplastic material, a key parameter is the cool down rate after the deposition of the material. When a part is made of thermoplastic material in an oven or press, the cool down rate is typically controlled by controlling the temperature in the oven or press by conduction or convection which allows the thermoplastic material for the entire part to be cooled in a control manner. In contrast, controlling the cool down rate of the thermoplastic deposited by 3D printing is difficult, in part, because the temperature of the thermoplastic material when deposited is substantially higher than the temperature of the area surrounding the deposited thermoplastic and because the thermoplastic material cools soon after the material is deposited and while printing of the part continues. During 3D printing, it is not practical to heat the surrounding area to the temperature at which the thermoplastic material is deposited until the entire part is printed and thereafter control the cool down temperature for thermoplastic material forming the part.

Crystallinity in the thermoplastic material forms as newly deposited thermoplastic cools. As crystallinity forms in the newly deposited thermoplastic material, printing of a part continues by depositing, e.g., printing, heated thermoplastic material that has not yet crystallized. Thus, thermoplastic material crystalizes in portions of a part at different times than in other portions of the part.

The printed thermoplastic material may be composed of different materials such as continuous fibers and a polymer(s). The thermal conductivities of each of these materials may differ. Further, a continuous fiber is a fiber that extends without interruption. A continuous element is an element, e.g., a fiber that extends without interrupting along the length of a filament of the thermoplastic material.

If the thermoplastic material includes a fiber(s), e.g., a continuous conductive element, and polymer(s), three factors influence the crystallinity of a deposited thermoplastic material. The three factors are: (1) differences between the thermal coefficients of the polymer and fiber in the material; (2) differences between the temperature of the thermoplastic material when deposited and the ambient temperature of the area surrounding the printing area for the part, and (3) the thermal conductivity of the fiber.

For 3D printing of a pure polymer material that has no reinforcement, there are two temperatures to be controlled. The first is the temperature of the nozzle head of the 3D printing machine which prints the polymer. This temperature should be high enough to allow the polymer material to be in a melted condition during printing to ensure fusion of the filament of polymer material and the surface of the part on which the material is printed. The second temperature to be controlled is the ambient temperature surrounding the printing area. The ambient temperature is maintained at a certain level to allow deposited polymer material to cool in a proper condition to avoid residual strengths and stresses in the printed part which may induce warping and loss of mechanical properties of the part.

These controlled temperatures become more important as the melting temperature of the thermoplastic material printed is higher than the melting temperature of conventional thermoplastic materials.

High-performance thermoplastics (e.g. polyether-ether-ketone (PEEK) and polyaryletherketone PAEK) are promising for aerospace applications, but high melting temperatures such as up to 400° C. Due to the high melting temperatures, the cool down rates of PEEK and PAEK thermoplastics and associated crystallization are even more important than with other thermoplastic materials having a lower melt temperature.

The polymer at a high melt temperature is printed from the nozzle head temperature and cools down to ambient temperature. The cool down rate and transition to crystallinity depends on the thermal conductivity of the thermoplastics, the ambient temperature and the speed of the 3D printing machine. Another factor is that the print nozzle indirectly heats the region of the part where the material is printed.

In a 3D printing machine of continuous fiber and polymer material, another factor is the high thermal conductivity of the fiber cools the material quickly after being printed which transfers heat from the printed to other areas of the printed material.

The thermal differences among nozzle, fiber and ambient make it difficult to control the crystallinity of the thermoplastic material due to the rapid cooling of the material.

### SUMMARY

A three-dimensional printing system has been invented that heats a continuous conductive element, e.g., a fiber, to a certain level that mitigates the effects produced by the loss of temperature.

The printing system comprises: a printing bed where a printed material, e.g., PEEK and PEAK, is deposited for forming a part; a bobbin configured for holding a filament of thermoplastic material reinforced with a continuous electrically conductive element, e.g., fiber; a printing head configured to fed the thermoplastic material reinforced with continuous electrically conductive fiber from the bobbin to a print head, e.g., nozzle; and a power supply and first and second electrodes. The printing head is configured to deposit the thermoplastic material onto the printing bed and the part being formed. The pair of first and second electrodes are connected to the power supply. The first electrode being electrically connected to the printing bed and the second electrode being electrically connected to the thermoplastic material reinforced with continuous electrically conductive fiber. A conductive electric circuit is created that allows current to flow through the continuous fiber of the thermoplastic material. The current heats the continuous fiber and heats the printed material.

Advantages of the printing system includes: homogeneous temperature of thermoplastic and fiber during the cooling process to ensure a proper crystallization during printing and once the printing process is finished; avoidance of undesired warping effects; improved mechanical properties of the finished part which is important because continuous fiber is added to tackle structural parts' reduced temperature differences, the crystallinity of the polymer around the fiber is facilitated and therefore, the mechanical properties of the final composite are also increased.

The current in the continuous fiber and the resulting heating of the fiber is used to heat the deposited thermoplastic material from when the material is printed and as the material cools.

By applying to the Joule effect, the electrically conductive fiber can be heated to achieve a goal of reducing temperature differences between the deposited thermoplastic and ambient temperature. The heat generated by current in the conductive fiber may be represented by:

Q=I²x·R·xt

where Q is total amount of energy transferred, I is electrical current, R is electrical resistance, and t is time.

The reinforced with continuous electrically conductive fiber in the thermoplastic material is used to control the cooling of the of the material after it is deposited by a 3D print head. To heat the fiber, the conductivity of the fiber is used to form an electric circuit that applies current to heat the fiber. By controlling the current in the fiber, the fiber temperature and the resulting thermal transference from the printing zone to the rest of the part can be controlled.

The 3D printing machine will apply the thermoplastic material reinforced with continuous fiber over the printing bed building up the part and generating the electric circuit. During the printing process, fiber is heated to control the cooling rate of the deposited thermoplastic and increasing or maintaining the temperature similar to the ambient of the area where the nozzle is printing the material.

### SUMMARY OF FIGURES

To complete the description and to provide for a better understanding of the invention, a set of drawings is provided. The drawings form an integral part of the description and illustrate embodiments of the invention. The drawings comprise the following figures.

FIG. 1 shows a schematic perspective view of an embodiment of the printing system object.

FIG. 2 shows a schematic lateral view of a second embodiment of the printing system object.

FIG. 3 is a cross section illustration of an exemplary filament including a thermoplastic material reinforced with a continuous electrically conductive fiber.

### DETAILED DESCRIPTION

FIGS. 1 and 2 depict two embodiments of a three-dimensional printing system. Both figures show an object, e.g., part, (1) that is being printed FIG. 2 specifically shows a filament (2) of thermoplastic material reinforced with continuous electrically conductive fiber.

FIGS. 1 and 2 shows an object (1), e.g., part, that is being printed. The figures show the printed material forming the object as the material is being printed.

The printing system comprises: a printing bed (3) where the object (1) is being printed, a bobbin (4) holding a filament (2) of thermoplastic material reinforced with continuous carbon fiber; a printing head (5) fed by the thermoplastic material reinforced with continuous carbon fiber from the bobbin (4) and depositing the printed material onto the printing bed (3); a power supply (6), and a pair of first and second electrodes (7, 8) connected to the power supply (6). The first electrode (7) is electrically connected to the printing bed (3). The second electrode (8) is electrically connected to the printing head (5) in FIG. 1 or to the bobbin (4) in FIG. 2. The power supply (6), such as a source of DC or AC electrical current, is electrically connected to the first and second electrodes.

In the embodiment shown in FIG. 2, the printing head (5) is configured for being electrically connected to the thermoplastic material reinforced with continuous electrically conductive element (2). For instance, the printed head (5) may be conductive or at least the portion of the printed head (5) in contact with the electrode and extending towards a surface of the printing head (5) in contact with the thermoplastic material.

In the embodiment shown in FIG. 3, the second electrode (8) is electrically connected to the bobbin (4). The bobbin (4) is configured for being electrically connected to the thermoplastic material reinforced with continuous electrically conductive element (2). As explained above, the bobbin (4) may be conductive or at least the portion of the bobbin (4) in contact with the electrode and extending towards a surface of the bobbin (4) in contact with the thermoplastic material.

The electrically conductive fiber is carbon fiber. Alternatively, the electrically conductive fiber may comprise an electrically conductive coating to make the fiber conductive.

The thermoplastic material may be polyether-ether-ketone (PEEK) and/or polyaryletherketone PAEK. The conductive fiber may be embedded within a sleeve of the thermoplastic material. Examples a thermoplastic material reinforced with continuous electrically conductive fiber are disclosed in WO 2015/077262, which is incorporated by reference with respect to its disclosure of multilayered filaments for 3D printing.

FIG. 3 shows a cross section of the filament (2) with a sheath (9) of a thermoplastic material, such as PEEK and/or PAEK, surrounding a conductive continuous fiber (10), such as a carbon fiber which may have an electrically conductive coating (11). The continuous fiber (10) may extend continuously from the filament on the bobbin (4) to the deposited material which forms the part (1) while being formed on the platform (3). The continuous fiber forms an electrically conductive path through the filament while the filament is on the bobbin, moving through the print head and deposited on the printing bed or on previously deposited filament material to form the part.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

The invention is:

1. A three-dimensional printing system for printing an object from a filament including a thermoplastic material reinforced with a continuous electrically conductive element, the three-dimensional printing system comprising:
a printing bed,
a bobbin holding a filament of the thermoplastic material reinforced with continuous electrically conductive element,
a print head coupled to the bobbin such that the filament moves from the bobbin to the print head, wherein the print head is configured to deposit the filament on the printing bed or on printed material being deposited on the printing bed,
a power supply,
first and second electrodes connected to the power supply, wherein the first electrode is electrically connected to the printing bed, and the second electrode is electrically connected to the continuous electrically conductive element in the filament at the print head or at the bobbin,
wherein an electric circuit is created through the continuous element of the thermoplastic material to heat the printed material.

2. The three-dimensional printing system according to claim 1, wherein the second electrode is electrically connected to the printing head, and the printing head is configured to be electrically connected to the continuous electrically conductive element in the filament.

3. The three-dimensional printing to claim 1, wherein the second electrode is electrically connected to the bobbin, and the bobbin is electrically connected to continuous electrically conductive element in the filament.

4. The three-dimensional printing system according to claim 1, wherein the electrically conductive fiber includes a carbon fiber.

5. The three-dimensional printing system according to claim 1, wherein the electrically conductive fiber comprises an electrically conductive coating.

6. An additive manufacturing system comprising:
a source of a filament of the thermoplastic material reinforced with continuous conductive element,
a print head configured to receive the filament from the source and deposit the filament on a print bed or on a part being formed on the print bed; and
an electrical circuit including the continuous conductive fiber and configured to be coupled to a power source, wherein the electrical circuit applies current to heat the conductive fiber at least while the conductive element is on the print bead or while the part is on the print bed.

7. The additive manufacturing system of claim 6, wherein the print head is configured to heat the filament to at least a melting point of the thermoplastic material such that the thermoplastic material is melted when deposited on the print bed or the part.

8. The additive manufacturing system of claim 6, wherein the electrical circuit includes a first electrode electrically connecting the power source to the conductive element while at the source or moving through the print head.

9. The additive manufacturing system of claim 8, wherein the electrical circuit includes a second electrode electrically connected to the print bed and the print bed is included in the electrical circuit.

10. The additive manufacturing system of claim 6, wherein the source is a bobbin and the filament is unwound from the bobbin to move to the print head.

11. The additive manufacturing system of claim 6, further comprising a housing enclosing the print head, print bed and part, wherein the source is external to the housing and the electrical circuit includes a first electrode connected to the continuous conductive element while at the source and a second electrode electrically connected to the print bed.

12. A method for additive manufacturing including:
delivering a filament of the thermoplastic material reinforced with continuous conductive element from a source to a print head,
depositing the filament by the print head on a print bed or on a part being formed on the print bed;
applying electrical current through the continuous conductive element while the conductive element is on the print bead or while the part is on the print bed, and
heating the thermoplastic material due to resistance in the continuous conductive element to the electrical current, wherein the heating of the thermoplastic material maintains the part at an elevated temperature while the part is being formed on the print bed.

13. The method of claim 12, further comprising heating the filament to at least a melting point of the thermoplastic material as the filament is deposited by the print head.

14. The method of claim 12, wherein the electrical circuit includes a first electrode electrically connecting the power source to the conductive element while at the filament is sorted on a source from which the filament moves to the print head.

15. The method of claim 14, wherein the electrical circuit includes a second electrode electrically connected to the print bed and the electrical current is applied to the print bed.

16. The method of claim 12, wherein the delivery of the filament includes unwinding the filament from a bobbin and the electrical current is applied to the filament while on the bobbin.
